(19) United States
(12) Patent Application Publication
(10) Pub. No.: US 2022/0383357 A1
(43) Pub. Date: Dec. 1, 2022

(54) Systems for a Personalized Uniform Resource Locator Encoded for Full Chain-of-Attribution

(71) Applicant: Amplify.ai, Los Altos, CA (US)

(72) Inventors: Mahi de Silva, Los Altos Hills, CA (US); Manoj Malhotra, Los Altos, CA (US); John McCrea, Palo Alto, CA (US)

(21) Appl. No.: 17/827,460

(22) Filed: May 27, 2022

Related U.S. Application Data
(60) Provisional application No. 63/195,586, filed on Jun. 1, 2021.

(51) Int. Cl. G06Q 30/02; G06F 16/955

(52) U.S. Cl. CPC G06Q 30/0242; G06F 16/955; G06Q 30/0269; G06Q 30/0277

(57) ABSTRACT

Systems for a personalized Uniform Resource Locator (URL) encoded for full chain-of-attribution enabling exponential growth marketing are disclosed. Some embodiments may include: generating a personalized Uniform Resource Locator (URL) for a creator, the personalized URL being encoded for full chain-of-attribution by being specific for the creator, the personalized URL comprising a protocol, an Internet Protocol address, and a sub-directory, the sub-directory being specific for the creator, providing the personalized URL to the creator for sharing with a plurality of followers of the creator, receiving registration data of click inputs by the plurality of followers on the personalized URL, generating a destination Uniform Resource Locator based on the click inputs by the plurality of followers on the personalized URL, the destination URL being encoded for the full chain-of-attribution by being specific for the creator and specific for a destination.

### RELATED APPLICATION

This patent application claims priority and the benefit of U.S. Utility Patent Application Ser. No. 63/195,586, filed Jun. 1, 2021. The aforementioned disclosure is hereby incorporated by reference herein in its entirety including all references cited therein.

### FIELD OF INVENTION

The present disclosure relates to systems, apparatus, and storage media for systems of a personalized Uniform Resource Locator encoded for full chain-of-attribution.

### SUMMARY

In some aspects, the techniques described herein relate to a system, including: one or more hardware processors configured by machine-readable instructions to: generate a personalized Uniform Resource Locator for a creator, the personalized URL being encoded for full chain-of-attribution by being specific for the creator, the personalized URL including a protocol, an Internet Protocol address, and a sub-directory, the sub-directory being specific for the creator; provide the personalized URL to the creator for sharing with a plurality of followers of the creator; receive registration data of click inputs by the plurality of followers on the personalized URL; generate a destination Uniform Resource Locator based on the click inputs by the plurality of followers on the personalized URL, the destination URL being encoded for the full chain-of-attribution by being specific for the creator and specific for a destination, the destination URL including a protocol, an Internet Protocol address, and a sub-directory, the sub-directory being specific for the destination; provide the destination URL to the plurality of followers, the providing the destination URL including replacing the personalized URL with the destination URL in real-time; receive option-in for messaging from the plurality of followers of the creator based on interaction of the plurality of followers with the destination URL, the interaction of the plurality of followers with the destination URL including two tap inputs on the destination URL by each follower of the plurality of followers; update a data record of the creator with a number of referrals based on the receiving option-in for the messaging; and provide gamification to the creator using the full chain-of-attribution, the gamification using the data record of the creator with the number of referrals.

In some aspects, the techniques described herein relate to a system, wherein the one or more hardware processors are further configured by machine-readable instructions to: send a brand related message to each follower of the plurality of followers based on the receiving option-in for the messaging.

In some aspects, the techniques described herein relate to a system, wherein the brand related message includes at least one of: a short messaging service (SMS) message, a Multimedia Messaging Service (MMS) message, and an over-the-top (OTT) message.

In some aspects, the techniques described herein relate to a system, wherein the protocol of the personalized Uniform Resource Locator (URL) includes at least one of Hypertext Transfer Protocol (HTTP) and HTTP Secure (HTTPS).

In some aspects, the techniques described herein relate to a system, wherein the gamification including a leaderboard, the leaderboard including a ranking of the creator compared with other creators based on the data record of the creator with the number of referrals.

In some aspects, the techniques described herein relate to a system, wherein the one or more hardware processors are further configured by machine-readable instructions to: receive registration data of a click input by a referral follower of the plurality of followers on the personalized URL; tag the referral follower as a current referring affiliate of the creator; and update the data record of the creator including the number of referrals based on a number of referring affiliates.

In some aspects, the techniques described herein relate to a system, wherein the one or more hardware processors are further configured by machine-readable instructions to: update the gamification to the creator using the full chain-of-attribution, the updating the gamification using the number of referring affiliates.

In some aspects, the techniques described herein relate to an apparatus, including: at least one memory storing computer program instructions; and at least one processor configured to execute the computer program instructions to cause the apparatus at least to: generate a personalized Uniform Resource Locator for a creator, the personalized URL being encoded for full chain-of-attribution by being specific for the creator, the personalized URL including a protocol, an Internet Protocol address, and a sub-directory, the sub-directory being specific for the creator; provide the personalized URL to the creator for sharing with a plurality of followers of the creator; receive registration data of click inputs by the plurality of followers on the personalized URL; generate a destination Uniform Resource Locator based on the click inputs by the plurality of followers on the personalized URL, the destination URL being encoded for the full chain-of-attribution by being specific for the creator and specific for a destination, the destination URL including a protocol, an Internet Protocol address, and a sub-directory, the sub-directory being specific for the destination; provide the destination URL to the plurality of followers, the providing the destination URL including replacing the personalized URL with the destination URL in real-time; receive option-in for messaging from the plurality of followers of the creator based on interaction of the plurality of followers with the destination URL, the interaction of the plurality of followers with the destination URL including two tap inputs on the destination URL by each follower of the plurality of followers; update a data record of the creator with a number of referrals based on the receiving option-in for the messaging; and provide gamification to the creator using the full chain-of-attribution, the gamification using the data record of the creator with the number of referrals.

In some aspects, the techniques described herein relate to an apparatus, wherein the at least one memory and the computer program code are further configured to, with the processor, cause the apparatus to send a brand related message to each follower of the plurality of followers based on the receiving option-in for the messaging.

In some aspects, the techniques described herein relate to an apparatus, wherein the brand related message includes at least one of: a short messaging service (SMS) message, a Multimedia Messaging Service (MMS) message, and an over-the-top (OTT) message.

In some aspects, the techniques described herein relate to an apparatus, wherein the protocol of the personalized Uniform Resource Locator (URL) includes at least one of Hypertext Transfer Protocol (HTTP) and HTTP Secure (HTTPS).

In some aspects, the techniques described herein relate to an apparatus, wherein the gamification including a leaderboard, the leaderboard including a ranking of the creator compared with other creators based on the data record of the creator with the number of referrals.

In some aspects, the techniques described herein relate to an apparatus, wherein the at least one memory and the computer program code are further configured to, with the processor, cause the apparatus to receive registration data of a click input by a referral follower of the plurality of followers on the personalized URL; tag the referral follower as a current referring affiliate of the creator; and update the data record of the creator including the number of referrals based on a number of referring affiliates.

In some aspects, the techniques described herein relate to an apparatus, wherein the at least one memory and the computer program code are further configured to, with the processor, cause the apparatus to update the gamification to the creator using the full chain-of-attribution, the updating the gamification using the number of referring affiliates.

In some aspects, the techniques described herein relate to a non-transient computer-readable storage medium including instructions being executable by one or more processors to perform a method, the method including: generating a personalized Uniform Resource Locator for a creator, the personalized URL being encoded for full chain-of-attribution by being specific for the creator, the personalized URL including a protocol, an Internet Protocol address, and a sub-directory, the sub-directory being specific for the creator; providing the personalized URL to the creator for sharing with a plurality of followers of the creator; receiving registration data of click inputs by the plurality of followers on the personalized URL; generating a destination Uniform Resource Locator based on the click inputs by the plurality of followers on the personalized URL, the destination URL being encoded for the full chain-of-attribution by being specific for the creator and specific for a destination, the destination URL including a protocol, an Internet Protocol address, and a sub-directory, the sub-directory being specific for the destination; providing the destination URL to the plurality of followers, the providing the destination URL including replacing the personalized URL with the destination URL in real-time; receiving option-in for messaging from the plurality of followers of the creator based on interaction of the plurality of followers with the destination URL, the interaction of the plurality of followers with the destination URL including two tap inputs on the destination URL by each follower of the plurality of followers; updating a data record of the creator with a number of referrals based on the receiving option-in for the messaging; and providing gamification to the creator using the full chain-of-attribution, the gamification using the data record of the creator with the number of referrals.

In some aspects, the techniques described herein relate to a computer-readable storage medium, wherein the at least one memory and the computer program code are further configured to, with the processor, cause the computer-readable storage medium to send a brand related message to each follower of the plurality of followers based on the receiving option-in for the messaging.

In some aspects, the techniques described herein relate to a computer-readable storage medium, wherein the brand related message includes at least one of: a short messaging service (SMS) message, a Multimedia Messaging Service (MMS) message, and an over-the-top (OTT) message.

In some aspects, the techniques described herein relate to a computer-readable storage medium, wherein the protocol of the personalized Uniform Resource Locator (URL) includes at least one of Hypertext Transfer Protocol (HTTP) and HTTP Secure (HTTPS).

In some aspects, the techniques described herein relate to a computer-readable storage medium, wherein the gamification including a leaderboard, the leaderboard including a ranking of the creator compared with other creators based on the data record of the creator with the number of referrals.

In some aspects, the techniques described herein relate to a computer-readable storage medium, wherein the at least one memory and the computer program code are further configured to, with the processor, cause the computer-readable storage medium to receive registration data of a click input by a referral follower of the plurality of followers on the personalized URL; tag the referral follower as a current referring affiliate of the creator; and update the data record of the creator including the number of referrals based on a number of referring affiliates.

In some aspects, the techniques described herein relate to a computer-readable storage medium, wherein the at least one memory and the computer program code are further configured to, with the processor, cause the computer-readable storage medium to update the gamification to the creator using the full chain-of-attribution, the updating the gamification using the number of referring affiliates.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is an exemplary link encoded for full chain-of-attribution according to exemplary embodiments of the present technology.

FIG. 2 is an exemplary screenshot of a social media interface including the link encoded for full chain-of-attribution according to exemplary embodiments of the present technology.

FIG. 3 is a user interface showing an SMS popup to two-tap option-in according to exemplary embodiments of the present technology.

FIG. 4 is a user interface according to exemplary embodiments of the present technology.

FIG. 5 is a user interface showing the chain-of-influence and according to exemplary embodiments of the present technology.

FIG. 6 is a user interface showing the chain-of-influence including gamifying sharing and according to exemplary embodiments of the present technology.

FIG. 7 illustrates a system configured for a personalized Uniform Resource Locator (URL) encoded for full chain-of-attribution enabling exponential growth marketing according to exemplary embodiments of the present technology.

FIG. 8A, FIG. 8B, FIG. 8C, and FIG. 8D illustrates a method for using a personalized Uniform Resource Locator (URL) encoded for full chain-of-attribution for exponential growth marketing according to exemplary embodiments of the present technology.

FIG. 9 illustrates a computer system according to exemplary embodiments of the present technology.

### DETAILED DESCRIPTION

While the present technology is susceptible of embodiment in many different forms, there is shown in the drawings and will herein be described in detail several specific embodiments with the understanding that the present disclosure is to be considered as an exemplification of the principles of the present technology and is not intended to limit the technology to the embodiments illustrated.

Embodiments of the present technology enable the first exponential market platform that fully exploits the culture graph. The present technology enables sequencing and instrumenting of “influence chains” end-to-end and at scale. For example, an “influence chains” may include the following:

Celebrities.

Creators/Influencers.

Friends.

Friends-of-friends.

Friends-of-friends-of-friends . . . .

In various embodiments, the “influence chains” may continue without limit for an exponential growth of a messaging service, all the way to purchase and monetization.

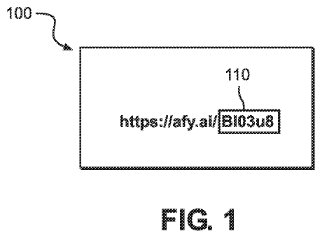

FIG. 1 is an exemplary link encoded for full chain-of-attribution according to exemplary embodiments of the present technology. The present technology uses personalized links, discount codes that are encoded for full chain-of-attribution to drive viral growth of SMS option-ins and purchases. For example, systems of the present technology may include generating a personalized short link for a creator, the personalized short link being encoded for full chain-of-attribution.

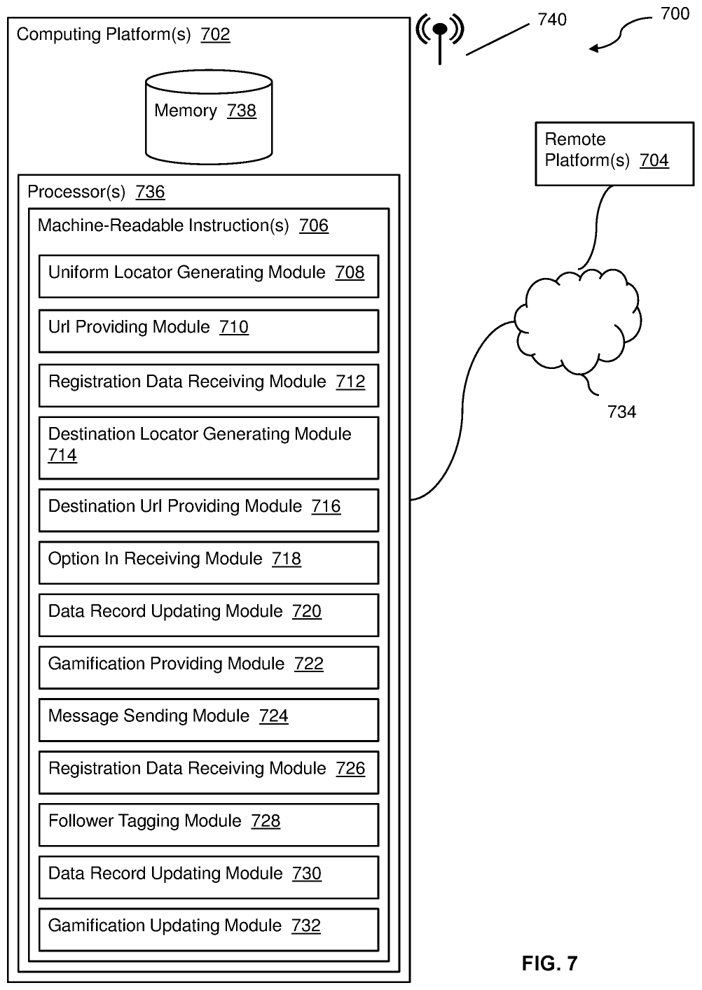

In various embodiments the present technology includes a system (as shown in FIG. 7) comprising: one or more hardware processors configured by machine-readable instructions to: generate a personalized Uniform Resource Locator 100 for a creator, the personalized URL 100 being encoded for full chain-of-attribution by being specific for the creator, the personalized URL 100 comprising a protocol, an Internet Protocol address, and a sub-directory 110, the sub-directory 110 being specific for the creator.

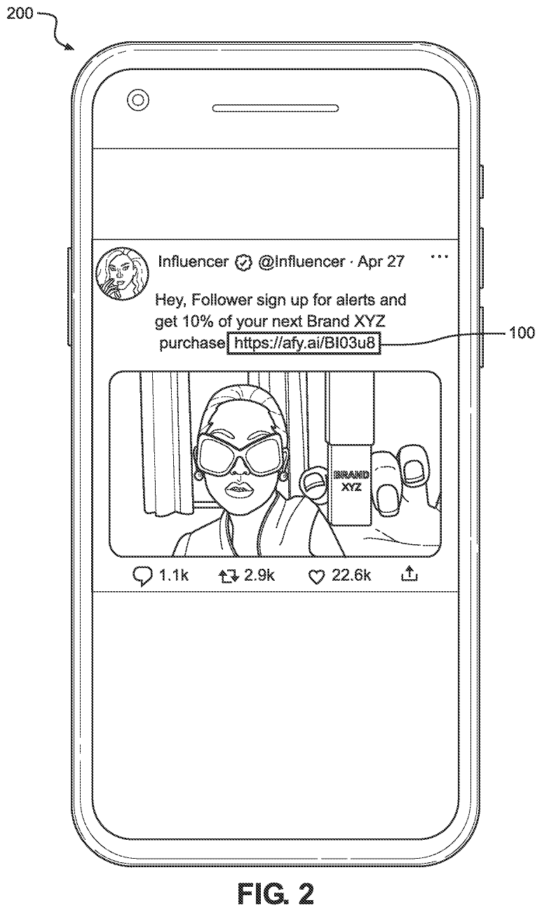

FIG. 2 is an exemplary screenshot 200 of a social media interface including the link encoded for full chain-of-attribution according to exemplary embodiments of the present technology. For example, a celebrity or social media influencer (e.g., Lady Gaga, may have a personalized link (encoded for full chain-of-attribution) sitting atop thousands of chains-of-attribution each started by one of her followers as shown in FIG. 2.

In various embodiments the present technology includes a system (as shown in FIG. 7) comprising: one or more hardware processors configured by machine-readable instructions to: provide the personalized URL 100 to the creator (e.g. Lady Gaga) for sharing with a plurality of followers of the creator; and receive registration data of click inputs by the plurality of followers on the personalized URL 100;

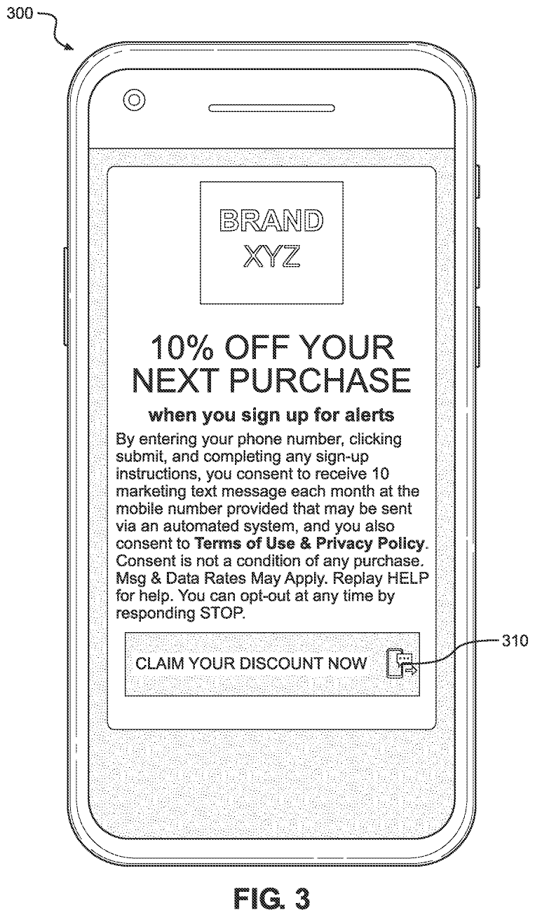

FIG. 3 is a user interface 300 showing an SMS popup to two-tap option-in according to exemplary embodiments of the present technology. FIG. 3 shows a pop-up screen on the interface of a user that awaits, after clicking on the link encoded for full chain-of-attribution and in just two taps the user is opted-in to marketing SMS texts. For example, systems of the present technology may include receiving option-in for short messaging service (SMS/WhatsApp/Facebook Messenger) texts from a plurality of followers of the creator using the personalized short link for the creator, the option-in for the short messaging service (SMS/WhatsApp/Facebook Messenger) texts comprising two taps by each follower of the plurality of followers of the creator. For example, one of 84+ million Twitter followers of Lady Gaga option-in for short messaging service (SMS) texts using the link encoded for full chain-of-attribution. For instance, systems of the present technology may include receiving user data from the plurality of followers based on interaction of the plurality of followers with the personalized short link. For example, meta data relating to the plurality of followers.

In various embodiments the present technology includes a system (as shown in FIG. 7) comprising: one or more hardware processors configured by machine-readable instructions to: generate a destination Uniform Resource Locator 310 based on the click inputs by the plurality of followers on the personalized URL 100, the destination URL 310 being encoded for the full chain-of-attribution by being specific for the creator and specific for a destination, the destination URL 310 comprising a protocol, an Internet Protocol address, and a sub-directory, the sub-directory being specific for the destination; and provide the destination URL 310 to the plurality of followers, the providing the destination URL 310 comprising replacing the personalized URL 100 with the destination URL 310 in real-time.

In various embodiments the present technology includes a system (as shown in FIG. 7) comprising: one or more hardware processors configured by machine-readable instructions to: receive option-in for messaging from the plurality of followers of the creator based on interaction of the plurality of followers with the destination URL 310, the interaction of the plurality of followers with the destination URL 310 comprising two tap inputs on the destination URL 310 by each follower of the plurality of followers; and update a data record of the creator with a number of referrals based on the receiving option-in for the messaging.

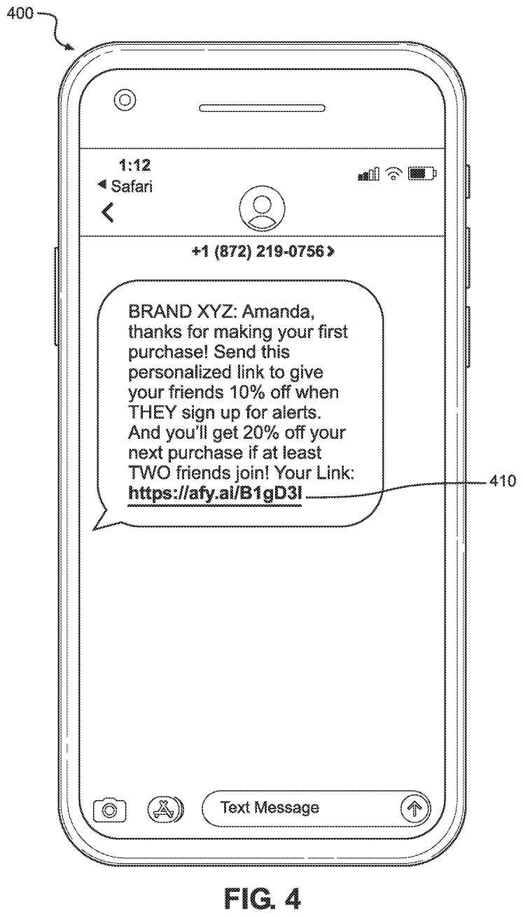

FIG. 4 is a user interface 400 according to exemplary embodiments of the present technology. Furthermore, as shown in FIG. 4 the marketing opportunities continue as after making a discounted purchase the user receives a personalized text from a brand. For instance, systems of the present technology may include sending a brand related short messaging service (SMS/WhatsApp/Facebook Messenger) text to the plurality of followers based on the receiving option-in for the short messaging service (SMS/WhatsApp/Facebook Messenger) texts and the user data from the plurality of followers. For example, the present technology may generate a personalized Uniform Resource Locator 410 for a follower of the creator, the personalized URL 410 being encoded for full chain-of-attribution by being specific for the follower of the creator, the personalized URL 410 comprising a protocol, an Internet Protocol address, and a sub-directory, the sub-directory being specific for the follower. The personalized URL 410 May be similar to the personalized URL 100 being encoded for full chain-of-attribution by being specific for the creator in various embodiments.

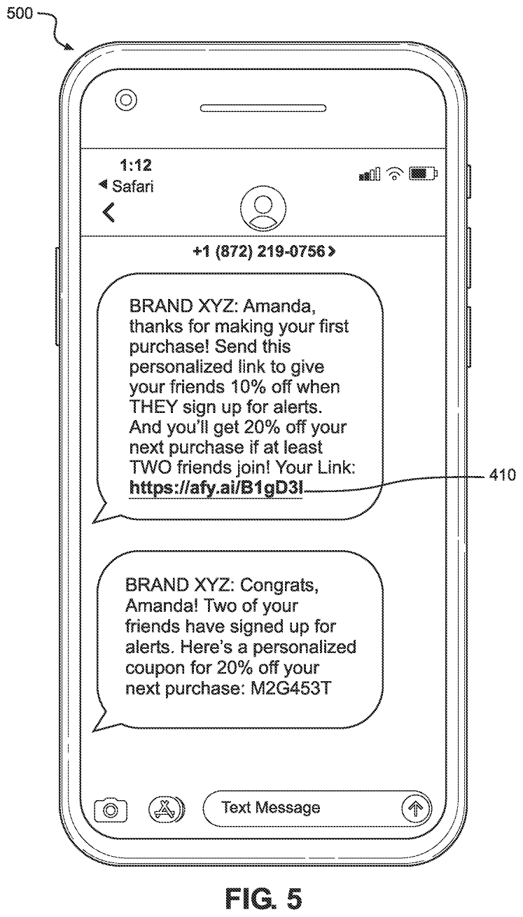

FIG. 5 is a user interface 500 showing the chain-of-influence and according to exemplary embodiments of the present technology. As shown in FIG. 5, the user may SMS text the link to three of her friends using the personalized URL 410 being encoded for full chain-of-attribution by being specific for the follower of the creator, and an hour later, the user gets another message from the brand.

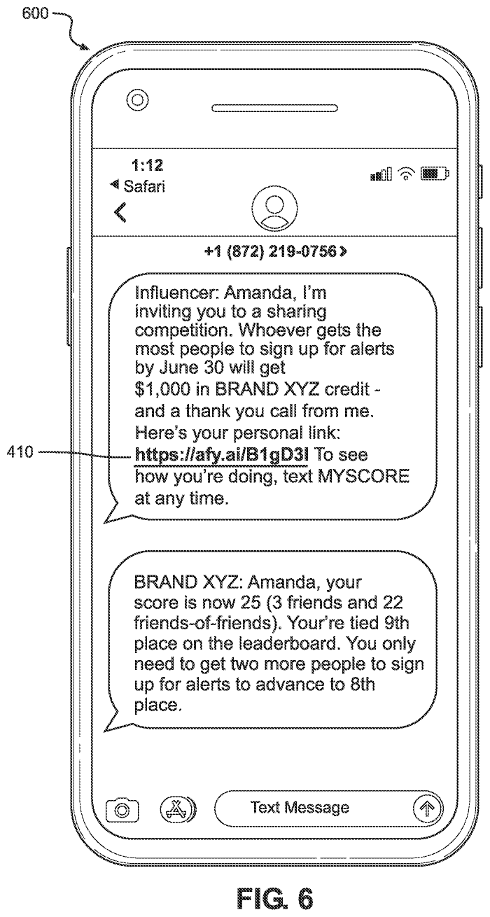

FIG. 6 is a user interface 600 showing the chain-of-influence including gamifying sharing and according to exemplary embodiments of the present technology. For example, the present technology enables the gamify of sharing for users including a “My Score” and a virtual leaderboard to incentivize users to continue sharing using the personalized URL 410, the personalized URL 410 being encoded for full chain-of-attribution by being specific for the follower of the creator. For instance, systems of the present technology may include providing gamification of the plurality of users based on the full chain-of-attribution, the gamification of the plurality of users including a leaderboard.

In some embodiments, each celebrity/influencer/creator may be given the same brand prize package for their own virtual leaderboard, and each can add their own incentive and let each celebrity/influencer/creator to compete for most impactful Culture Graph. For example, each celebrity/influencer/creator may provide a brand prize package such as cocktail/coffee with the celebrity/influencer/creator.

In various exemplary embodiments, the results from the chain-of-influence for the first twenty-four hours in an exemplary embodiments were 20,342 SMS option-ins, and $650,586.66 in purchases, and Amanda being in in fifth place on a virtual leaderboard, with a score of two-hundred-and-twenty-five. The present technology enables unlocking exponential growth in SMS option-ins for consumer brand clients that also drive exponential growth of our messaging revenue.

In various embodiments the present technology includes a system (as shown in FIG. 7) comprising: one or more hardware processors configured by machine-readable instructions to: provide gamification to the creator using the full chain-of-attribution, the gamification using the data record of the creator with the number of referrals.

FIG. 7 illustrates a system configured for a personalized Uniform Resource Locator (URL) encoded for full chain-of-attribution enabling exponential growth marketing, in accordance with one or more embodiments. In some cases, system 700 may include one or more computing platforms 702. The one or more computing platforms 702 may be communicably coupled with one or more remote platforms 704. In some cases, users may access the system 700 via remote platform(s) 704.

The one or more computing platforms 702 may be configured by machine-readable instructions 706. Machine-readable instructions 706 may include modules. The modules may be implemented as one or more of functional logic, hardware logic, electronic circuitry, software modules, and the like. The modules may include one or more of URL generating module 708, URL providing module 710, registration data receiving module 712, destination URL generating module 714, destination URL providing module 716, option in receiving module 718, data record updating module 720, gamification providing module 722, message sending module 724, registration data receiving module 726, follower tagging module 728, data record updating module 730, gamification updating module 732, and/or other modules.

URL generating module 708 may be configured to generate a personalized Uniform Resource Locator for a creator, the personalized URL being encoded for full chain-of-attribution by being specific for the creator, the personalized URL comprising a protocol, an Internet Protocol address, and a sub-directory, the sub-directory being specific for the creator. URL providing module 710 may be configured to provide the personalized URL to the creator for sharing with a plurality of followers of the creator. Registration data receiving module 712 may be configured to receive registration data of click inputs by the plurality of followers on the personalized URL. Destination URL generating module 714 may be configured to generate a destination Uniform Resource Locator based on the click inputs by the plurality of followers on the personalized URL, the destination URL being encoded for the full chain-of-attribution by being specific for the creator and specific for a destination, the destination URL comprise a protocol, an Internet Protocol address, and a sub-directory, the sub-directory being specific for the destination. Destination URL providing module 716 may be configured to provide the destination URL to the plurality of followers, the providing the destination URL comprising replacing the personalized URL with the destination URL in real-time. Option in receiving module 718 may be configured to receive option-in for messaging from the plurality of followers of the creator based on interaction of the plurality of followers with the destination URL, the interaction of the plurality of followers with the destination URL comprising two tap inputs on the destination URL by each follower of the plurality of followers. Data record updating module 720 may be configured to update a data record of the creator with a number of referrals based on the receiving option-in for the messaging. Gamification providing module 722 may be configured to provide gamification to the creator using the full chain-of-attribution, the gamification using the data record of the creator with the number of referrals.

Message sending module 724 may be configured to send a brand related message to each follower of the plurality of followers based on the receiving option-in for the messaging. In some cases, the brand related message comprises at least one of: a short messaging service message, a Multimedia Messaging Service message, and an over-the-top message.

In some cases, the protocol of the personalized Uniform Resource Locator comprises at least one of Hypertext Transfer Protocol and HTTP Secure and the gamification comprising a leaderboard, the leaderboard comprising a ranking of the creator compared with other creators based on the data record of the creator with the number of referrals.

Registration data receiving module 726 may be configured to receive registration data of a click input by a referral follower of the plurality of followers on the personalized URL. Follower tagging module 728 may be configured to tag the referral follower as a current referring affiliate of the creator. Data record updating module 730 may be configured to update the data record of the creator including the number of referrals based on a number of referring affiliates.

Gamification updating module 732 may be configured to update the gamification to the creator using the full chain-of-attribution, the updating the gamification using the number of referring affiliates.

In some cases, the one or more computing platforms 702, may be communicatively coupled to the remote platform(s) 704. In some cases, the communicative coupling may include communicative coupling through a networked environment 734. The networked environment 734 may be a radio access network, such as LTE or 5G, a local area network (LAN), a wide area network (WAN) such as the Internet, or wireless LAN (WLAN), for example. It will be appreciated that this is not intended to be limiting, and that the scope of this disclosure includes implementations in which one or more computing platforms 702 and remote platform(s) 704 may be operatively linked via some other communication coupling. The one or more one or more computing platforms 702 may be configured to communicate with the networked environment 734 via wireless or wired connections. In addition, in an embodiment, the one or more computing platforms 702 may be configured to communicate directly with each other via wireless or wired connections. Examples of one or more computing platforms 702 may include, but is not limited to, smartphones, wearable devices, tablets, laptop computers, desktop computers, Internet of Things (IoT) device, or other mobile or stationary devices. In an embodiment, system 700 may also include one or more hosts or servers, such as the one or more remote platforms 704 connected to the networked environment 734 through wireless or wired connections. According to one embodiment, remote platforms 704 may be implemented in or function as base stations (which may also be referred to as Node Bs or evolved Node Bs (eNBs)). In other embodiments, remote platforms 704 may include web servers, mail servers, application servers, etc. According to certain embodiments, remote platforms 704 may be standalone servers, networked servers, or an array of servers.

The one or more computing platforms 702 may include one or more processors 736 for processing information and executing instructions or operations. One or more processors 736 may be any type of general or specific purpose processor. In some cases, multiple processors 736 may be utilized according to other embodiments. In fact, the one or more processors 736 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. In some cases, the one or more processors 736 may be remote from the one or more computing platforms 702, such as disposed within a remote platform like the one or more remote platforms 704 of FIG. 7.

The one or more processors 736 may perform functions associated with the operation of system 700 which may include, for example, precoding of antenna gain/phase parameters, encoding and decoding of individual bits forming a communication message, formatting of information, and overall control of the one or more computing platforms 702, including processes related to management of communication resources.

The one or more computing platforms 702 may further include or be coupled to a memory 738 (internal or external), which may be coupled to one or more processors 736, for storing information and instructions that may be executed by one or more processors 736. Memory 738 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 738 can consist of any combination of random-access memory (RAM), read only memory (ROM), static storage such as a magnetic or optical disk, hard disk drive (HDD), or any other type of non-transitory machine or computer readable media. The instructions stored in memory 738 may include program instructions or computer program code that, when executed by one or more processors 736, enable the one or more computing platforms 702 to perform tasks as described herein.

In some embodiments, one or more computing platforms 702 may also include or be coupled to one or more antennas 740 for transmitting and receiving signals and/or data to and from one or more computing platforms 702. The one or more antennas 740 may be configured to communicate via, for example, a plurality of radio interfaces that may be coupled to the one or more antennas 740. The radio interfaces may correspond to a plurality of radio access technologies including one or more of LTE, 5G, WLAN, Bluetooth, near field communication (NFC), radio frequency identifier (RFID), ultrawideband (UWB), and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

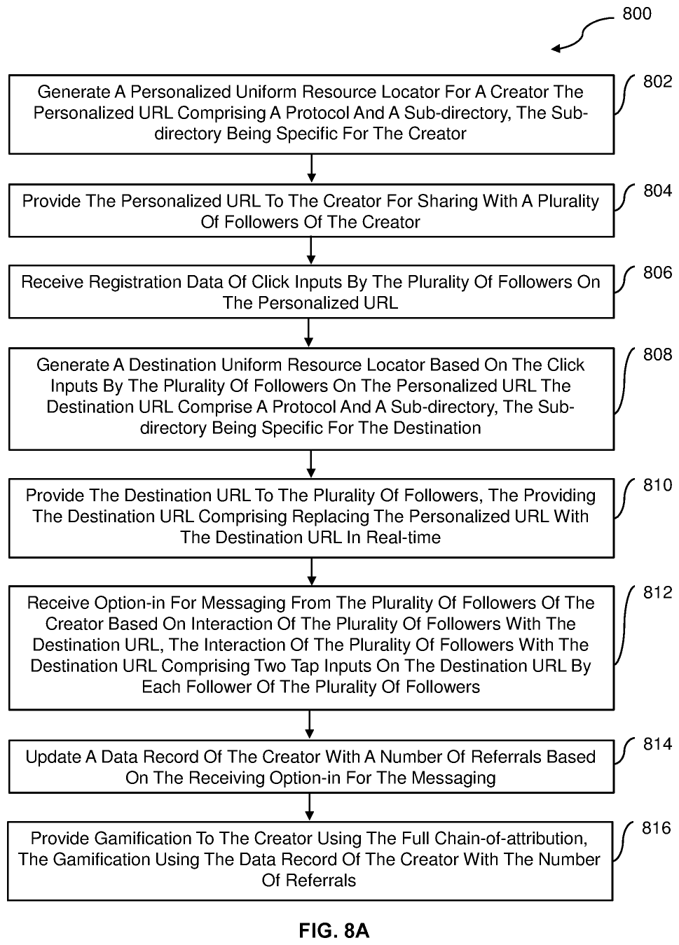

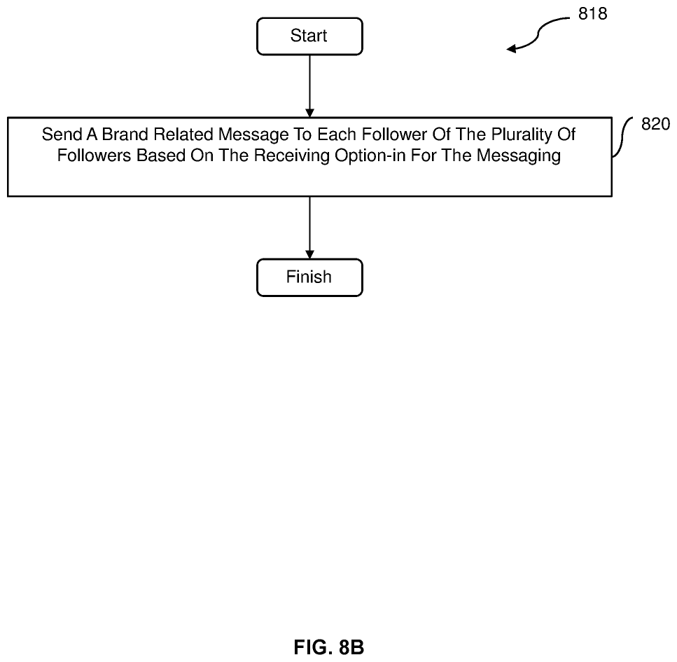

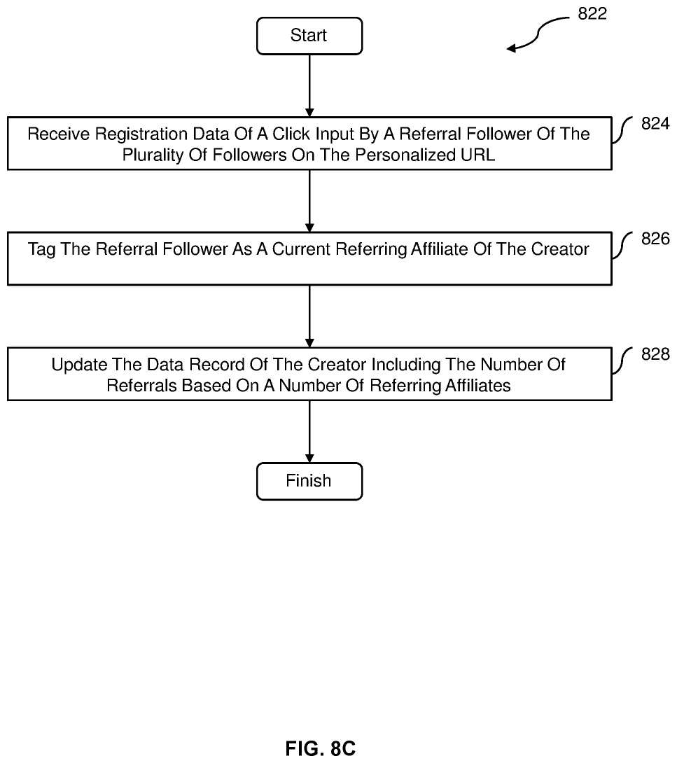

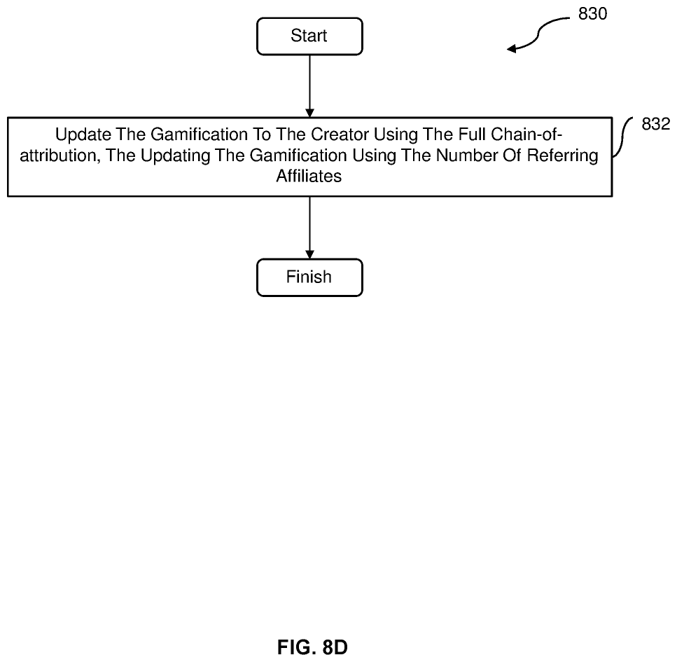

FIG. 8A, FIG. 8B, FIG. 8C and/or FIG. 8D illustrate an example flow diagram of a method 800, according to one embodiment. The method 800 may include generating a personalized Uniform Resource Locator for a creator, the personalized URL being encoded for full chain-of-attribution by being specific for the creator, the personalized URL comprising a protocol, an Internet Protocol address, and a sub-directory, the sub-directory being specific for the creator at block 802. The method 800 may include providing the personalized URL to the creator for sharing with a plurality of followers of the creator at block 804. The method 800 may include receiving registration data of click inputs by the plurality of followers on the personalized URL at block 806. The method 800 may include generating a destination Uniform Resource Locator based on the click inputs by the plurality of followers on the personalized URL, the destination URL being encoded for the full chain-of-attribution by being specific for the creator and specific for a destination, the destination URL comprising a protocol, an Internet Protocol address, and a sub-directory, the sub-directory being specific for the destination at block 808. The method 800 may include providing the destination URL to the plurality of followers, the providing the destination URL comprising replacing the personalized URL with the destination URL in real-time at block 810. The method 800 may include receiving option-in for messaging from the plurality of followers of the creator based on interaction of the plurality of followers with the destination URL, the interaction of the plurality of followers with the destination URL comprising two tap inputs on the destination URL by each follower of the plurality of followers at block 812. The method 800 may include updating a data record of the creator with a number of referrals based on the receiving option-in for the messaging at block 814. The method 800 may include providing gamification to the creator using the full chain-of-attribution, the gamification using the data record of the creator with the number of referrals at block 816.

In FIG. 8B, the method 800 may be continued at 818, and may further include sending a brand related message to each follower of the plurality of followers based on the receiving option-in for the messaging at block 820.

In FIG. 8C, the method 800 may be continued at 822, and may further include receiving registration data of a click input by a referral follower of the plurality of followers on the personalized URL at block 824. The method 800 continued at 822 may further include tagging the referral follower as a current referring affiliate of the creator at block 826. The method 800 continued at 822 may also further include updating the data record of the creator including the number of referrals based on a number of referring affiliates at block 828.

In FIG. 8D, the method 800 may be continued at 830, and may further include updating the gamification to the creator using the full chain-of-attribution, the updating the gamification using the number of referring affiliates at block 832.

In some cases, the method 800 may be performed by one or more hardware processors, such as the processors 736 of FIG. 7, configured by machine-readable instructions, such as the machine-readable instructions 706 of FIG. 7. In this aspect, the method 800 may be configured to be implemented by the modules, such as the URL generating module 708, URL providing module 710, registration data receiving module 712, destination URL generating module 714, destination URL providing module 716, option-in receiving module 718, data record updating module 720, gamification providing module 722, message sending module 724, registration data receiving module 726, follower tagging module 728, data record updating module 730 and/or gamification updating module 732 discussed above in FIG. 7.

Examples of exemplary embodiments are described herein. Alice is a registered user of “BigBrand's” (e.g. Brand XYZ's) SMS service with Amplify.ai. BigBrand (e.g. Brand XYZ) decides to run a promotion with three goals: raise awareness of their new BigWidget product, sell BigWidgets, and grow their SMS list. BigBrand (e.g. Brand XYZ) sends out an SMS broadcast announcing the campaign; each registered active user on that SMS list receives the same message but with a different URL, a URL which is specific to them and possibly to the BigWidget launch campaign. Alice receives the SMS message with her URL (https://afy.ai/23HI0) and instructions that for each person who clicks on her URL and signup for SMS, she will get an entry into a drawing for a free BigWidget. While there is no identifier of Alice visible in the URL, back in the Amplify.ai platform there is a linkage between Alice's URL (https://afy.ai/23HI0) and Alice. Alice cleverly posts her URL on all the social platforms she's on and also emails them to her friends and she herself sends it as an SMS to her family's WhatsApp group. Bob, Alice's neighbor and friend, sees Alice's Tweet on Twitter and decides to click her URL (https://afy.ai/23HI0) figuring he could try the same thing and maybe win a free BigWidget! When Bob clicks Alice's link he gets some marketing content related to BigWidget as well as his own URL (https://afy.ai/98Me2). While there is no identifier of Alice visible in the URL, back in the Amplify.ai platform there is a linkage between Bob's URL (https://afy.ai/98Me2) and Bob himself. There is also an identifier in Bob's profile with Amplify.ai indicating that he clicked Alice's URL and that Alice was his original referral and his current referral. By now Amplify.ai is aware of the connection between Alice and Bob and has shown the campaign marketing material to both of them. Each is also incentivized to drive the campaign further to market by sharing with their friends and family and on social. Alice has earned an entry into a drawing for a BigWidget. BigBrand's SMS list has grown by one. As Alice's link is clicked by more people, she will earn more entries (or possibly a cash earn or a revenue share or . . . ). If Bob does the same, he too will earn an entry (or payment) for each person he brings in.

Various embodiments of the present technology include the following options. Attribution of subsequent sales to both the proximal referral (e.g. Bob if someone clicks his link) as well as to the original referral (i.e. Alice can get partial credit for Bob's friend buying via Bob's link).

In various embodiments the present technology includes drawing entries (or points or a cash payout or a rev share) to Alice for Bob's referrals too. That is if Alice brings in five users including Bob and Bob brings in one-hundred users, the present technology may give Alice credit for one-hundred-and-five users (her five plus the one-hundred Bob brought) in addition to giving Bob credit for one-hundred.

In some embodiments the present technology includes the ability to show each user their current number of entries earned (or score/earn/points). This may be used for encouragement but also to incentivize competition if only the top five scores get the widget—that is that rather than randomly selecting from entries the present technology may count how many referrals and give the top five a BigWidget free. In various embodiments, setup automated broadcasts showing users their current score and interactive score lookup as well (e.g., Alice texts us “how many points do I have” and the current technology replies with her current standing).

### EP SUPPORT EXAMPLES

Example 1 includes a system comprising: generating a personalized Uniform Resource Locator for a creator, the personalized URL being encoded for full chain-of-attribution by being specific for the creator, the personalized URL comprising a protocol, an Internet Protocol address, and a sub-directory, the sub-directory being specific for the creator, providing the personalized URL to the creator for sharing with a plurality of followers of the creator, receiving registration data of click inputs by the plurality of followers on the personalized URL, generating a destination Uniform Resource Locator based on the click inputs by the plurality of followers on the personalized URL, the destination URL being encoded for the full chain-of-attribution by being specific for the creator and specific for a destination, the destination URL comprising a protocol, an Internet Protocol address, and a sub-directory, the sub-directory being specific for the destination, providing the destination URL to the plurality of followers, the providing the destination URL comprising replacing the personalized URL with the destination URL in real-time, receiving option-in for messaging from the plurality of followers of the creator based on interaction of the plurality of followers with the destination URL, the interaction of the plurality of followers with the destination URL comprising two tap inputs on the destination URL by each follower of the plurality of followers, updating a data record of the creator with a number of referrals based on the receiving option-in for the messaging and providing gamification to the creator using the full chain-of-attribution, the gamification using the data record of the creator with the number of referrals.

Example 2 includes the system of example(s) 1 and/or some other example(s) herein, further comprising: sending a brand related message to each follower of the plurality of followers based on the receiving option-in for the messaging.

Example 3 includes the system of example(s) 2 and/or some other example(s) herein, wherein the brand related message comprises at least one of: a short messaging service message, a Multimedia Messaging Service message, and an over-the-top message.

Example 4 includes the system of example(s) 1 and/or some other example(s) herein, wherein the protocol of the personalized Uniform Resource Locator comprises at least one of Hypertext Transfer Protocol and HTTP Secure.

Example 5 includes the system of example(s) 1 and/or some other example(s) herein, wherein the gamification comprising a leaderboard, the leaderboard comprising a ranking of the creator compared with other creators based on the data record of the creator with the number of referrals.

Example 6 includes the system of example(s) 1 and/or some other example(s) herein, further comprising: receiving registration data of a click input by a referral follower of the plurality of followers on the personalized URL; tagging the referral follower as a current referring affiliate of the creator; and updating the data record of the creator including the number of referrals based on a number of referring affiliates.

Example 7 includes the system of example(s) 6 and/or some other example(s) herein, further comprising: updating the gamification to the creator using the full chain-of-attribution, the updating the gamification using the number of referring affiliates.

Example 8 includes an apparatus comprising: generating a personalized Uniform Resource Locator for a creator, the personalized URL being encoded for full chain-of-attribution by being specific for the creator, the personalized URL comprising a protocol, an Internet Protocol address, and a sub-directory, the sub-directory being specific for the creator, providing the personalized URL to the creator for sharing with a plurality of followers of the creator, receiving registration data of click inputs by the plurality of followers on the personalized URL, generating a destination Uniform Resource Locator based on the click inputs by the plurality of followers on the personalized URL, the destination URL being encoded for the full chain-of-attribution by being specific for the creator and specific for a destination, the destination URL comprising a protocol, an Internet Protocol address, and a sub-directory, the sub-directory being specific for the destination, providing the destination URL to the plurality of followers, the providing the destination URL comprising replacing the personalized URL with the destination URL in real-time, receiving option-in for messaging from the plurality of followers of the creator based on interaction of the plurality of followers with the destination URL, the interaction of the plurality of followers with the destination URL comprising two tap inputs on the destination URL by each follower of the plurality of followers, updating a data record of the creator with a number of referrals based on the receiving option-in for the messaging and providing gamification to the creator using the full chain-of-attribution, the gamification using the data record of the creator with the number of referrals.

Example 9 includes the apparatus of example(s) 8 and/or some other example(s) herein, further comprising: sending a brand related message to each follower of the plurality of followers based on the receiving option-in for the messaging.

Example 10 includes the apparatus of example(s) 9 and/or some other example(s) herein, wherein the brand related message comprises at least one of: a short messaging service message, a Multimedia Messaging Service message, and an over-the-top message.

Example 11 includes the apparatus of example(s) 8 and/or some other example(s) herein, wherein the protocol of the personalized Uniform Resource Locator comprises at least one of Hypertext Transfer Protocol and HTTP Secure.

Example 12 includes the apparatus of example(s) 8 and/or some other example(s) herein, wherein the gamification comprising a leaderboard, the leaderboard comprising a ranking of the creator compared with other creators based on the data record of the creator with the number of referrals.

Example 13 includes the apparatus of example(s) 8 and/or some other example(s) herein, further comprising: receiving registration data of a click input by a referral follower of the plurality of followers on the personalized URL; tagging the referral follower as a current referring affiliate of the creator; and updating the data record of the creator including the number of referrals based on a number of referring affiliates.

Example 14 includes the apparatus of example(s) 13 and/or some other example(s) herein, further comprising: updating the gamification to the creator using the full chain-of-attribution, the updating the gamification using the number of referring affiliates.

Example 15 includes a storage medium comprising: generating a personalized Uniform Resource Locator for a creator, the personalized URL being encoded for full chain-of-attribution by being specific for the creator, the personalized URL comprising a protocol, an Internet Protocol address, and a sub-directory, the sub-directory being specific for the creator, providing the personalized URL to the creator for sharing with a plurality of followers of the creator, receiving registration data of click inputs by the plurality of followers on the personalized URL, generating a destination Uniform Resource Locator based on the click inputs by the plurality of followers on the personalized URL, the destination URL being encoded for the full chain-of-attribution by being specific for the creator and specific for a destination, the destination URL comprising a protocol, an Internet Protocol address, and a sub-directory, the sub-directory being specific for the destination, providing the destination URL to the plurality of followers, the providing the destination URL comprising replacing the personalized URL with the destination URL in real-time, receiving option-in for messaging from the plurality of followers of the creator based on interaction of the plurality of followers with the destination URL, the interaction of the plurality of followers with the destination URL comprising two tap inputs on the destination URL by each follower of the plurality of followers, updating a data record of the creator with a number of referrals based on the receiving option-in for the messaging and providing gamification to the creator using the full chain-of-attribution, the gamification using the data record of the creator with the number of referrals.

Example 16 includes the storage medium of example(s) 15 and/or some other example(s) herein, further comprising: sending a brand related message to each follower of the plurality of followers based on the receiving option-in for the messaging.

Example 17 includes the storage medium of example(s) 16 and/or some other example(s) herein, wherein the brand related message comprises at least one of: a short messaging service message, a Multimedia Messaging Service message, and an over-the-top message.

Example 18 includes the storage medium of example(s) 15 and/or some other example(s) herein, wherein the protocol of the personalized Uniform Resource Locator comprises at least one of Hypertext Transfer Protocol and HTTP Secure.

Example 19 includes the storage medium of example(s) 15 and/or some other example(s) herein, wherein the gamification comprising a leaderboard, the leaderboard comprising a ranking of the creator compared with other creators based on the data record of the creator with the number of referrals.

Example 20 includes the storage medium of example(s) 15 and/or some other example(s) herein, further comprising: receiving registration data of a click input by a referral follower of the plurality of followers on the personalized URL; tagging the referral follower as a current referring affiliate of the creator; and updating the data record of the creator including the number of referrals based on a number of referring affiliates.

Example 21 includes the storage medium of example(s) 20 and/or some other example(s) herein, further comprising: updating the gamification to the creator using the full chain-of-attribution, the updating the gamification using the number of referring affiliates.

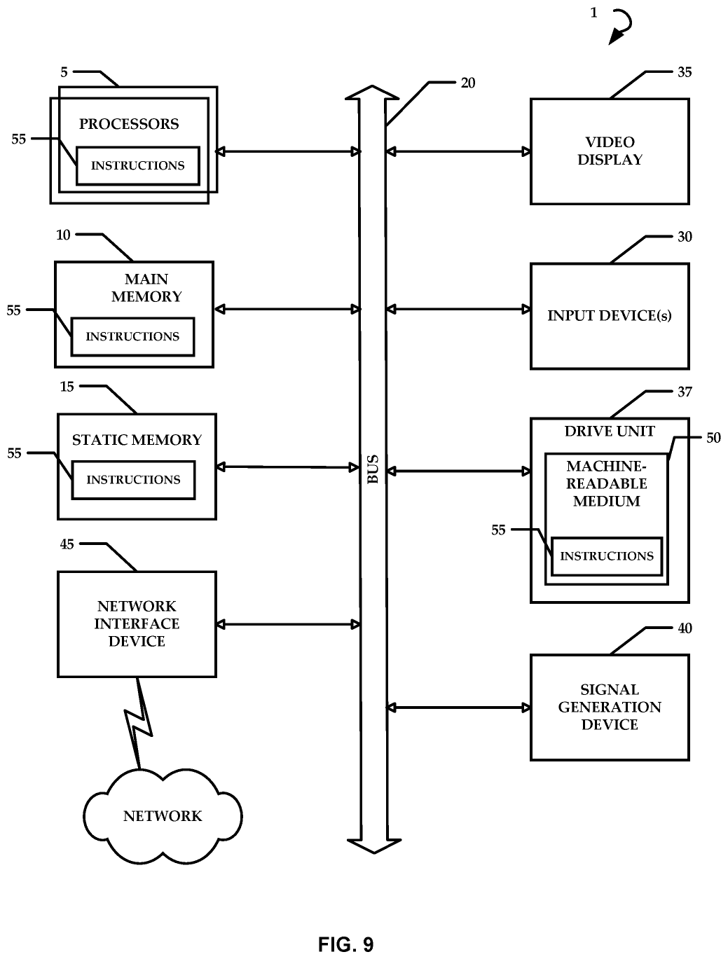

FIG. 9 illustrates a computer system according to exemplary embodiments of the present technology. FIG. 9 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The disk drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In the description, for purposes of explanation and not limitation, specific details are set forth, such as particular embodiments, procedures, techniques, etc. in order to provide a thorough understanding of the present technology. However, it will be apparent to one skilled in the art that the present technology may be practiced in other embodiments that depart from these specific details.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not limitation. The descriptions are not intended to limit the scope of the present technology to the particular forms set forth herein. To the contrary, the present descriptions are intended to cover such alternatives, modifications, and equivalents as may be included within the spirit and scope of the present technology as appreciated by one of ordinary skill in the art. Thus, the breadth and scope of a preferred embodiment should not be limited by any of the above-described exemplary embodiments.

What is claimed is:

1. A system, comprising:
one or more hardware processors configured by machine-readable instructions to:
generate a personalized Uniform Resource Locator for a creator, the personalized URL being encoded for full chain-of-attribution by being specific for the creator, the personalized URL comprising a protocol, an Internet Protocol address, and a sub-directory, the sub-directory being specific for the creator;
provide the personalized URL to the creator for sharing with a plurality of followers of the creator;
receive registration data of click inputs by the plurality of followers on the personalized URL;
generate a destination Uniform Resource Locator based on the click inputs by the plurality of followers on the personalized URL, the destination URL being encoded for the full chain-of-attribution by being specific for the creator and specific for a destination, the destination URL comprising a protocol, an Internet Protocol address, and a sub-directory, the sub-directory being specific for the destination;
provide the destination URL to the plurality of followers, the providing the destination URL comprising replacing the personalized URL with the destination URL in real-time;
receive option-in for messaging from the plurality of followers of the creator based on interaction of the plurality of followers with the destination URL, the interaction of the plurality of followers with the destination URL comprising two tap inputs on the destination URL by each follower of the plurality of followers;
update a data record of the creator with a number of referrals based on the receiving option-in for the messaging; and
provide gamification to the creator using the full chain-of-attribution, the gamification using the data record of the creator with the number of referrals.

2. The system of claim 1, wherein the one or more hardware processors are further configured by machine-readable instructions to: send a brand related message to each follower of the plurality of followers based on the receiving option-in for the messaging.

3. The system of claim 2, wherein the brand related message comprises at least one of: a short messaging service (SMS) message, a Multimedia Messaging Service (MMS) message, and an over-the-top (OTT) message.

4. The system of claim 1, wherein the protocol of the personalized Uniform Resource Locator (URL) comprises at least one of Hypertext Transfer Protocol (HTTP) and HTTP Secure (HTTPS).

5. The system of claim 1, wherein the gamification comprising a leaderboard, the leaderboard comprising a ranking of the creator compared with other creators based on the data record of the creator with the number of referrals.

6. The system of claim 1, wherein the one or more hardware processors are further configured by machine-readable instructions to: receive registration data of a click input by a referral follower of the plurality of followers on the personalized URL; tag the referral follower as a current referring affiliate of the creator; and update the data record of the creator including the number of referrals based on a number of referring affiliates.

7. The system of claim 6, wherein the one or more hardware processors are further configured by machine-readable instructions to: update the gamification to the creator using the full chain-of-attribution, the updating the gamification using the number of referring affiliates.

8. An apparatus, comprising:
at least one memory storing computer program instructions; and
at least one processor configured to execute the computer program instructions to cause the apparatus at least to:
generate a personalized Uniform Resource Locator for a creator, the personalized URL being encoded for full chain-of-attribution by being specific for the creator, the personalized URL comprising a protocol, an Internet Protocol address, and a sub-directory, the sub-directory being specific for the creator;
provide the personalized URL to the creator for sharing with a plurality of followers of the creator;
receive registration data of click inputs by the plurality of followers on the personalized URL;
generate a destination Uniform Resource Locator based on the click inputs by the plurality of followers on the personalized URL, the destination URL being encoded for the full chain-of-attribution by being specific for the creator and specific for a destination, the destination URL comprising a protocol, an Internet Protocol address, and a sub-directory, the sub-directory being specific for the destination;
provide the destination URL to the plurality of followers, the providing the destination URL comprising replacing the personalized URL with the destination URL in real-time;
receive option-in for messaging from the plurality of followers of the creator based on interaction of the plurality of followers with the destination URL, the interaction of the plurality of followers with the destination URL comprising two tap inputs on the destination URL by each follower of the plurality of followers;
update a data record of the creator with a number of referrals based on the receiving option-in for the messaging; and
provide gamification to the creator using the full chain-of-attribution, the gamification using the data record of the creator with the number of referrals.

9. The apparatus of claim 8, wherein the at least one memory and the computer program code are further configured to, with the processor, cause the apparatus to send a brand related message to each follower of the plurality of followers based on the receiving option-in for the messaging.

10. The apparatus of claim 9, wherein the brand related message comprises at least one of: a short messaging service (SMS) message, a Multimedia Messaging Service (MMS) message, and an over-the-top (OTT) message.

11. The apparatus of claim 8, wherein the protocol of the personalized Uniform Resource Locator (URL) comprises at least one of Hypertext Transfer Protocol (HTTP) and HTTP Secure (HTTPS).

12. The apparatus of claim 8, wherein the gamification comprising a leaderboard, the leaderboard comprising a ranking of the creator compared with other creators based on the data record of the creator with the number of referrals.

13. The apparatus of claim 8, wherein the at least one memory and the computer program code are further configured to, with the processor, cause the apparatus to receive registration data of a click input by a referral follower of the plurality of followers on the personalized URL; tag the referral follower as a current referring affiliate of the creator; and update the data record of the creator including the number of referrals based on a number of referring affiliates.

14. The apparatus of claim 13, wherein the at least one memory and the computer program code are further configured to, with the processor, cause the apparatus to update the gamification to the creator using the full chain-of-attribution, the updating the gamification using the number of referring affiliates.

15. A non-transient computer-readable storage medium comprising instructions being executable by one or more processors to perform a method, the method comprising:
generating a personalized Uniform Resource Locator for a creator, the personalized URL being encoded for full chain-of-attribution by being specific for the creator, the personalized URL comprising a protocol, an Internet Protocol address, and a sub-directory, the sub-directory being specific for the creator;
providing the personalized URL to the creator for sharing with a plurality of followers of the creator;
receiving registration data of click inputs by the plurality of followers on the personalized URL;
generating a destination Uniform Resource Locator based on the click inputs by the plurality of followers on the personalized URL, the destination URL being encoded for the full chain-of-attribution by being specific for the creator and specific for a destination, the destination URL comprising a protocol, an Internet Protocol address, and a sub-directory, the sub-directory being specific for the destination;
providing the destination URL to the plurality of followers, the providing the destination URL comprising replacing the personalized URL with the destination URL in real-time;
receiving option-in for messaging from the plurality of followers of the creator based on interaction of the plurality of followers with the destination URL, the interaction of the plurality of followers with the destination URL comprising two tap inputs on the destination URL by each follower of the plurality of followers;
updating a data record of the creator with a number of referrals based on the receiving option-in for the messaging; and
providing gamification to the creator using the full chain-of-attribution, the gamification using the data record of the creator with the number of referrals.

16. The computer-readable storage medium of claim 15, wherein the at least one memory and the computer program code are further configured to, with the processor, cause the computer-readable storage medium to send a brand related message to each follower of the plurality of followers based on the receiving option-in for the messaging.

17. The computer-readable storage medium of claim 16, wherein the brand related message comprises at least one of: a short messaging service (SMS) message, a Multimedia Messaging Service (MMS) message, and an over-the-top (OTT) message.

18. The computer-readable storage medium of claim 15, wherein the protocol of the personalized Uniform Resource Locator (URL) comprises at least one of Hypertext Transfer Protocol (HTTP) and HTTP Secure (HTTPS).

19. The computer-readable storage medium of claim 15, wherein the gamification comprising a leaderboard, the leaderboard comprising a ranking of the creator compared with other creators based on the data record of the creator with the number of referrals.

20. The computer-readable storage medium of claim 15, wherein the at least one memory and the computer program code are further configured to, with the processor, cause the computer-readable storage medium to receive registration data of a click input by a referral follower of the plurality of followers on the personalized URL; tag the referral follower as a current referring affiliate of the creator; and update the data record of the creator including the number of referrals based on a number of referring affiliates.

21. The computer-readable storage medium of claim 20, wherein the at least one memory and the computer program code are further configured to, with the processor, cause the computer-readable storage medium to update the gamification to the creator using the full chain-of-attribution, the updating the gamification using the number of referring affiliates.
